(19) United States
(12) Patent Application Publication
(10) Pub. No.: US 2025/0045781 A1
(43) Pub. Date: Feb. 6, 2025

(54) SELF-SUPERVISED CHURN PREDICTIONS

(71) Applicant: NCR Voyix Corporation, Atlanta, GA (US)

(72) Inventors: Thomas Philip Murray, New York, NY (US); Pavan Kumar Vattyam, Atlanta, GA (US); Kyle Alexander King, Bogart, GA (US); Chase Tyler Nicholson, Atlanta, GA (US); Norman Leonard Trujillo, Frisco, TX (US); Kun Zhu, Smyrna, GA (US)

(21) Appl. No.: 18/228,242

(22) Filed: Jul. 31, 2023

(51) Int. Cl. G06Q 30/0202; G06N 20/00; G06Q 30/0204

(52) U.S. Cl. CPC G06Q 30/0202; G06N 20/00; G06Q 30/0204

(57) ABSTRACT

Features from historical transaction and customer data of a financial institution are calculated and/or extracted. Each customer is assigned to a given profitability cluster within each interval of time over a historical period of time based on the corresponding features. A self-supervised machine learning model is trained on the features to predict the clusters in a future interval of time. Features for a most-recent past interval of time are provided as input to the model and the model returns a predicted cluster for a given customer in a future interval of time. When the customer-assigned cluster in the most-recent past interval of time is a higher prioritized cluster than the predicted cluster for the future interval of time, a system of a financial institution (FI) is notified to take one or more mitigating in an attempt to prevent customer churn with the FI.

### BACKGROUND

A principle observed across industry is that it is more expensive to acquire customers than retain customers. Industries such as banking, have a challenging time even identifying their customer churn.

This is largely because customers have the freedom to switch banks without providing explicit notice, making it challenging to track their customers behaviors accurately. Additionally, customers may have assorted reasons for leaving, such as dissatisfaction with services or better offers from competitors. As a result, banks often do not even realize that a customer has left making it extremely difficult for them to predict customer churn. Other industries require monthly subscription fees or require their customers to affirmatively notify the business when customers leave. Banks do not have this luxury or opportunity to discover why customers leave.

Still, banks attempt to identify customer churn through deterministic rules that rely on domain knowledge to identify customers they believe are still customers in an attempt to generate marketing campaigns to retain those customers. Often the customers targeted in the campaigns have already left the business of the bank or had no plans of leaving the bank, which means the campaigns are often a waste of limited resources and costly to the banks.

### SUMMARY

In various embodiments, a system and methods for self-supervised churn predictions are presented. A first machine learning model (“model”) is trained on features relevant to profitability of customers to a financial institution (FI) for purposes of clustering customers into profitability clusters over a historical interval of time. The first model assigns each customer to a profitability cluster over each sub interval of time within the historical interval of time. A second model is trained using the clustered sub-intervals of time to predict the clusters when provided the features as input. During operation, features for a most recent interval of past time are obtained and provided as input to the second model. The second model outputs, for each customer, a predicted profitability cluster in a future interval of time. Each customer-assigned profitability cluster within the most recent interval of past time is compared against the corresponding customer-assigned predicted profitability cluster for the future interval of time. When a customer's predicted profitability cluster is a lower profitability cluster from the cluster assigned in the most recent interval of past time, the customer is flagged as a potential customer churn for the FI. Systems of the FI are notified of flagged customers associated with potential churn so that actions can be taken for the FI to avoid the corresponding churn.

### BRIEF DESCRIPTION OF THE DRAWINGS

FIG. 1 is a diagram of a system for self-supervised churn predictions, according to an example embodiment.

FIG. 2 is a flow diagram of a method for self-supervised churn predictions, according to an example embodiment.

FIG. 3 is a flow diagram of another method for self-supervised churn predictions, according to an example embodiment.

### DETAILED DESCRIPTION

Even though churn is an understood topic in industries, such as retail, other industries, such as financial industries, struggle with accurately identifying when churn has taking place and how to identify their customers who may be contemplating leaving the business of the financial institutions (FIs). Additionally, there are a considerable number of small banks, which lack the resources to invest heavily in data science activities, such that a viable solution remains elusive.

The techniques presented herein and below resolve these issues. Because a FI rarely truly knows whether there are experiencing customer churn, a novel technique is presented by which churn is predicted based on predicted movement in each customer's classification or cluster from a higher prioritized cluster associated with a current interval of time into a predicted lower prioritized cluster for a future interval of time. Predicted movement to a lower prioritized cluster from a previously higher prioritized cluster identifies a FI's customer that is likely to churn. Based on determining a potential customer churn, the FI institutes mitigation actions to prevent the potential churn from occurring in the future interval of time.

The methods and system provided utilizes at least two machine-learning models (hereinafter just “models”). A first model is trained on features, extracted, and calculated from historical data to cluster customers into categories for a given interval of time. The second model is trained on the features to predict the clusters produced by the first model for a future interval of time. A given customer's clusters are monitored to identify a predicted customer's cluster which is predicted to move from higher prioritized cluster in a first interval of time to a lower prioritized cluster in a second future interval of time, which indicates potential customer churn. In an embodiment, a third model is trained to map a predicted customer churn to a FI-specific action known to have a high probability of preventing the potential customer churn; for example, a promotion, an offer, or a reward is provided to a system of FI causing the system to automatically deliver the promotion, offer, or reward to the customer associated with the potential customer churn. In an embodiment, the features used to train the first model are the same or are different from the features used to train the second model.

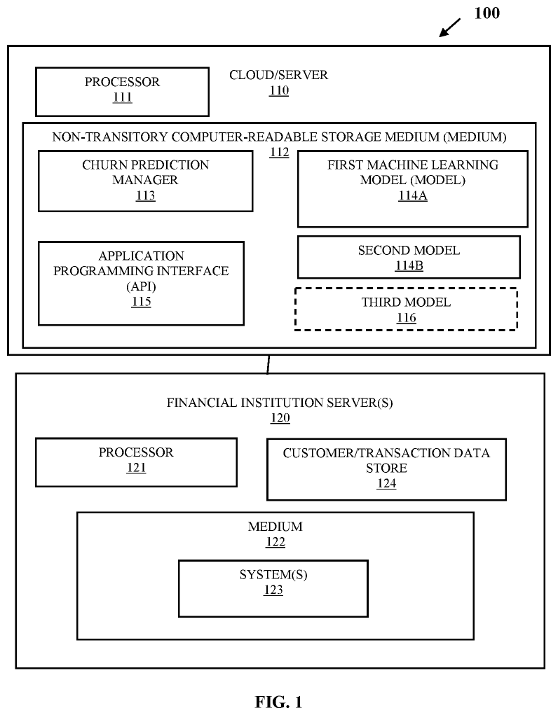

Within this initial context, various embodiments are now presented with reference to the FIGS. FIG. 1 is a diagram of a system 100 for self-supervised churn predictions, according to an example embodiment, the components are shown schematically in simplified form, with only those components relevant to understanding of the embodiments being illustrated.

Furthermore, the various components illustrated in FIG. 1 and their arrangement are presented for purposes of illustration only. Other arrangements with more or less components are possible without departing from the teachings of self-supervised churn predictions as presented herein and below.

System 100 includes a cloud/server 110 (hereinafter just “cloud 110”) and one or more FI servers 120. Cloud 110 includes at least one processor 111 and a non-transitory computer-readable storage medium (hereinafter just “medium”) 112, which includes executable instructions for a churn prediction manager 113, a first model 114A, a second model 114, an application programming interface (API) 115, and, optionally, a third model 116. When the processor executes the instructions are, the processor 111 performs operations discussed herein and below with respect to 113, 114A, 114B, 115, and optionally, 116.

Each FI server 120 includes a processor 121 and medium 112, which includes executable instructions for systems 123. The instructions when executed by processor 121 perform operations discussed herein and below with respect to systems 123. Each FI server 120 further includes a customer/transaction data store 124. The customer/transaction data store 124 includes data for customer identifiers, customer transactions, type of transactions (e.g., credit, debit, loan), data and time of day for each transaction, location and device associated with each transaction, loan types, loan terms, customer creation date, insufficient fund violations, deposit balance by data and time, channel costs, profit per transaction, interchange fees, customer age, customer fees, customer accounts, customer financial service products, customer demographic data, etc.

Initially, historical customer and transactional data (collectively referred to as “historical data”) for customers of a given FI is obtained from the corresponding data store 124 of the corresponding FI server 120. Features are extracted from the data and/or calculated from the data for each customer. In an embodiment, the features are extracted and/or calculated over preconfigured interval of time from the historical data. For example, the features are extracted and/or calculated over a monthly interval of time for the entire historical period of time. In an embodiment, at least three features are calculated as an average time between transactions for the given month (i.e., recency of transactions for the month), a total number or of transactions for the corresponding month (i.e., frequency of transactions for the month), and a sum a corresponding customer's checking account spending for the month, balances of accounts for the month (e.g., savings, retirement, certificates of deposit, etc.), and any outstanding loan balances for the month (i.e., customer's monetary value to the FI). The features represent a FI equivalent of recency, frequency, and monetary value (RFM) for each customer during each month for the entire period represented within the historical data. In an embodiment, additional features are calculated from the historical data for each month; for example, average credit spending, average number of transactions over the previous 6 months in the historical data, average debit card transactions, a total number of customer subscriptions for products/services of the FI for the month, etc. In an embodiment, other or additional features are extracted from the historical data; for example, demographic data of each customer such as age, marital status, job status, employer, any children, ages of children, home geographic location, etc.

The features are provided as input to a first model 114A that clusters the customers for each month of the historical period into clusters based on the features. In an embodiment, the first model 114A is restricted to a predefined number of clusters or an upper bound on a total number of permissible clusters (e.g., no more than N clusters, where N is 3, greater than 3 but less than 7, etc.). In an embodiment, the predefined number of clusters include a low value customer cluster, a medium value customer cluster, and a high value customer cluster.

Output from clustering the historical data by customer for each sub interval in a predefined interval of time is used for training a second model 114B. The features are provided as input to the second model 114B with the labeled clusters representing the expected output by the second model 114B. This results in a predictive model 114B from which predictive clusters for each customer for a future interval of time is provided when the second model 114B is provided features for a given past interval of time (e.g., past, and most recent three months or six months transactional and customer data for a given customer).

After training, the second model 114B is evaluated for accuracy metrics using the historical data. For example, churn prediction manager 113 provides the features for the past three months of June, July, and August of 2021 as input to the second model 114B for purposes of providing a predicted cluster for a given customer for November 2021. Since, the given customer's cluster classification is known for November 2021, churn prediction manager 113 compares the second model's predicted customer cluster against the corresponding customer's known cluster for November 2021. Once the second model 114B has been trained and acceptable accuracy metrics are obtained above a threshold level, the second model 114B is released to a production environment from which the given FI receives notices, reports, and/or recommendations for customers who are predicted to churn or predicted to leave the FI at some point in the future interval of time. The second model 114B learns how to predict a customer's future cluster during its training.

Instead of defining churn as when a customer leaves a FI; churn is defined as when a currently active and profitable customer will become less profitable to the FI. Once the initial profitability clusters are created for the groups/categories of low, medium, and high (and/or variations of additional clusters within a range of low to high) from the historical data by first model 114A and once second model 114B is trained, second model 114B can run unsupervised and learn to predict a customer's cluster for a given future interval of time based on features calculated and extracted from the customer's actual transaction/customer data. In this way, the first model 114A need only process on the historical data and not on newly generated transaction/customer data; model 114B provides the probabilities of lower profitability itself by predicting the clusters for the newly generated transaction/customer data.

In an embodiment, a most recent interval of time with a given customer's cluster designation by month (sub-interval of time) and a predicted cluster for the customer received from the second model are used to train a third model 116 to generate as output actions to take in view of a predicted movement of a customer from a high profitability cluster to a low probability cluster. The actions processed by the FI include, by way of example only, sending an API 115 message to a given system 123 of the FI causing the system 123 to flag a customer record, automatically issue a promotion to the customer, post and display the customer as a potential churn within dashboards of employees of the FI, and other configured operations.

With the churn predictions (probabilities) received from second mode 114B, churn prediction manager 113 isolates and prioritizes churn targets (specific customers) based on a given customer's probability to churn and based how profitable the corresponding customer has been in the past to the FI. Churn prediction manager 113 identifies customers who were recently in a high/medium profitability cluster that have a high probability to move to a low profitability cluster in the future interval of time.

After training of models 114A, 114B, and optionally, 116, churn prediction manager 113 executes are a configured interval of time, for example, every month. During operation of system 100, churn prediction manager 113 obtains current transaction/customer data from customer/transaction data store 124 for a most-recent interval of time, for example, the past three months, the past six months, or other configured past intervals of time. Churn prediction manager 113 calculates, by customer, the first features, and extracts second demographic features from the data as discussed above. Churn prediction manager 113 provides the features as input to second model 114B, which returns as output a predicted cluster for the customer in a future interval of time, for example, for a next month, for three months out from a current date, etc.

Churn prediction manager 113 receives the predicted cluster as output from second model 114B and compares the predicted cluster against a current cluster assigned to the customer for a current interval of time, for example, current month. When the predicted cluster represents a potential movement of the customer from a higher prioritized or valued cluster of the current customer assigned cluster to a lower prioritized or valued cluster in the future interval of time, churn prediction manager 113 performs one or more configured actions. The actions can include using API 115 to cause a dashboard interface associated with employee interfaces of the FI to display the customer's identifier/name and a status notification of a potential churn customer. The actions can also include generating a report for all of the potential churn customers identified in the future interval of time and using the API 115 to deliver the report to a given system 123 of the FI. In an embodiment, the churn prediction manager 113 provides the current calculated and extracted features for the most recent or current interval of time, the corresponding customer assigned clusters within the current interval of time, and the predicted cluster for the future interval of time as input to third model 116. Third model 116 outputs one or more actions to the churn prediction manager 113 and churn prediction manager 113 processes the one or more actions using API 115 to interact and to notify systems 123.

In an embodiment, the churn prediction manager 113 can also identify customers of lower profitability predicted to move to higher profitability in the future interval of time from the most-recent assigned customer clusters and the predicted cluster. Churn prediction manager 113 processes one or more additional actions to notify or to cause systems 123 to perform operations with respect to these customers. That is, a FI may want to reward or at least recognize customers as they become more profitable to the FI to establish stronger customer loyalty to the FI.

In an embodiment, the first model 114A is a K-means clustering model. In an embodiment, the first model 114A is unsupervised, the second model 114B is supervised during training for cluster prediction (using labeled clusters provided by the first model 114A as its supervision), but during production release the second model 114B can be viewed as a whole as being a self-supervised machine learning model (“model”). In an embodiment, at preconfigured intervals of time, churn prediction manager 113 retrains the first model 114A on actual transaction/customer data to include more of less clusters and/or to use one or more additional calculated or extracted features.

System 100 address issues faced by Fls in accurately forecasting customer churn by accounting for the unique circumstances of Fls and their customers. Features relevant to profitability are identified, calculated, and extracted and provided to first model 114A, which clusters the customers into varying degrees of profitability over any given interval of time. The output from the first model 114A is used to train second model 114B to receive as input the features and provide as output a predicted cluster of each customer within a given future of interval of time. The second model 114B is then processes as a self-supervised model without requiring any manual intervention and/or retraining unless the first model 114A is retrained with more or less features and/or more of less cluster designations. Churn prediction manager 113 monitors each customer's profitability cluster from interval to interval (e.g., month to month) in view of the second model's predicted profitability cluster for the corresponding customer in a future interval of time. When the predicted cluster is a lower prioritized or profitability cluster from a previous or current interval of time, churn prediction manager 113 performs one or more configured actions to notify and/or to cause systems 123 to proactively address each customer predicted to churn in the future interval of time.

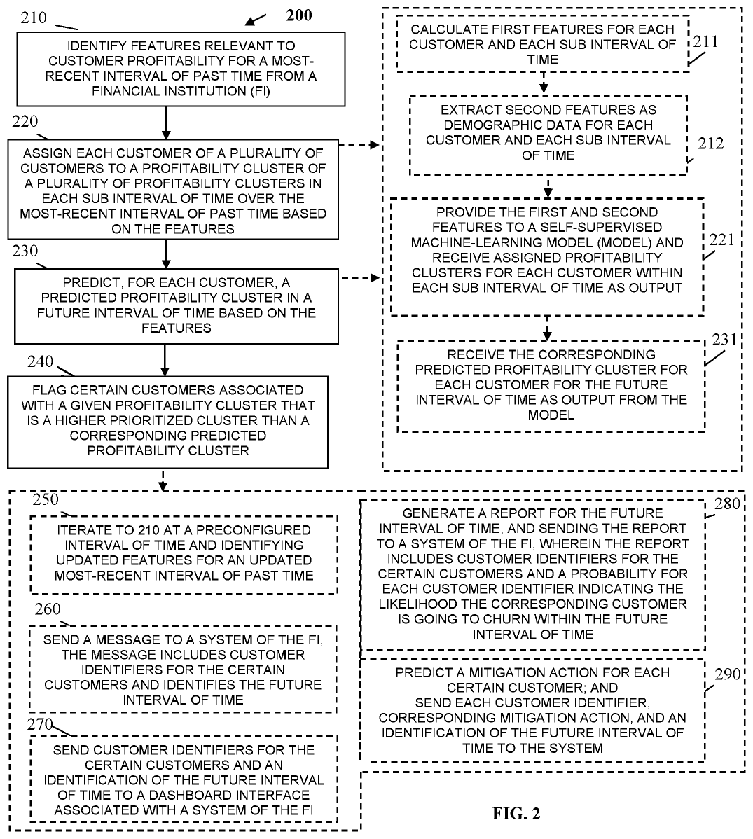

FIG. 2 is a flow diagram of a method 200 for self-supervised churn predictions, according to an example embodiment. The software module(s) that implements the method 200 is referred to as a “FI customer churn predictor.” The FI customer churn predictor is implemented as executable instructions programmed and residing within memory and/or a non-transitory computer-readable (processor-readable) storage medium and executed by one or more processors of one or more devices. The processor(s) of the device(s) that executes the FI customer churn predictor are specifically configured and programmed to process the FI customer churn predictor. The FI customer churn predictor has access to one or more network connections during its processing. The connections can be wired, wireless, or a combination of wired and wireless.

In an embodiment, the device that executes the FI customer churn predictor is cloud 110 or server 110. In an embodiment, server 110 is a server of a given FI server 120 that manages branches. In an embodiment, the FI customer churn predictor is a portion, all, or any combination of, predictor 113, 114A, 114B, 115, and/or 116.

At 210, FI customer churn predictor identifies features relevant to customer profitability for a most-recent interval of past time from a FI. In an embodiment, at 211, the FI customer churn predictor calculates first features for each customer and each sub interval of time within the most-recent past interval of time. The first features include calculating an average time between transactions within each sub interval of time, a total number of transactions for each sub interval of time, and a sum of customer checking spend, and balances of customer savings, retirement, certificate accounts, and customer outstanding loan balances. These first features represent features that are relevant to a FI for RFM. In an embodiment of 211 and at 212, the FI customer churn predictor extracts second features as demographic data for each customer and each sub interval of time. The FI customer churn predictor calculates and extracts the first features and the second features from the customer/transaction data store or a transaction and data store.

At 220, the FI customer churn predictor assigns each customer of a plurality customers to a profitability cluster of a plurality of profitability clusters in each sub interval of time over the most-recent interval of past time based on the features. In an embodiment of 220 and 212, at 221, the FI customer churn predictor provides the first and second features to a self-supervised model 114B as input and receives assigned profitability clusters for each customer within each sub interval of time as output from model 114B.

At 230, the FI customer churn predictor predicts, for each customer, a predicted profitability cluster in a future interval of time based on the features. In an embodiment of 230 and 221, at 231, the FI customer churn predictor receives the corresponding predicted profitability cluster for each customer for the future interval of time as additional output from the model 114B.

At 240, the FI customer churn predictor flags certain customers associated with a given profitability cluster that is a higher prioritized profitability cluster than a corresponding predicted profitability cluster. That is, the predicted cluster is a lower profitability cluster than the given profitability cluster for a given certain customer within the most-recent interval of past time. This is an indication that the customer is becoming less profitable and therefore likely to churn.

In an embodiment, at 250, the FI customer churn predictor iterates to 210 at a preconfigured interval of time and identifies updated features for an updated most-recent interval of past time. In other words, the FI customer churn predictor updates the features and the data for the most-recent interval of past time to account for transaction and customer data that was unprocessed between the preconfigured interval of time.

In an embodiment, at 260, the FI customer churn predictor sends a message to a system 123 of the FI. The message includes customer identifiers for the certain customers and identifies the future interval of time.

In an embodiment, at 270, the FI customer churn predictor sends customer identifiers for the certain customers and identification of the future interval of time to a dashboard interface associated with a system 123 of the FI. The customer identifiers overlaid on screens of displays for devices operated by employees of the FI, such as tellers, clerks, branch managers, loan officers, etc.

In an embodiment, at 280, the FI customer churn predictor generates a report for the future interval of time. The FI customer churn predictor sends the report to a system 123 of the FI; the report includes customer identifiers for the certain customers and a probability for each customer identifier indicating the likelihood the corresponding customer is going to churn within the future interval of time.

In an embodiment, at 290, the FI customer churn predictor predicts a mitigation action for each certain customer. The FI customer churn predictor sends each customer identifier, a corresponding mitigation action, and an identification of the future interval of time to the system 123 of the FI.

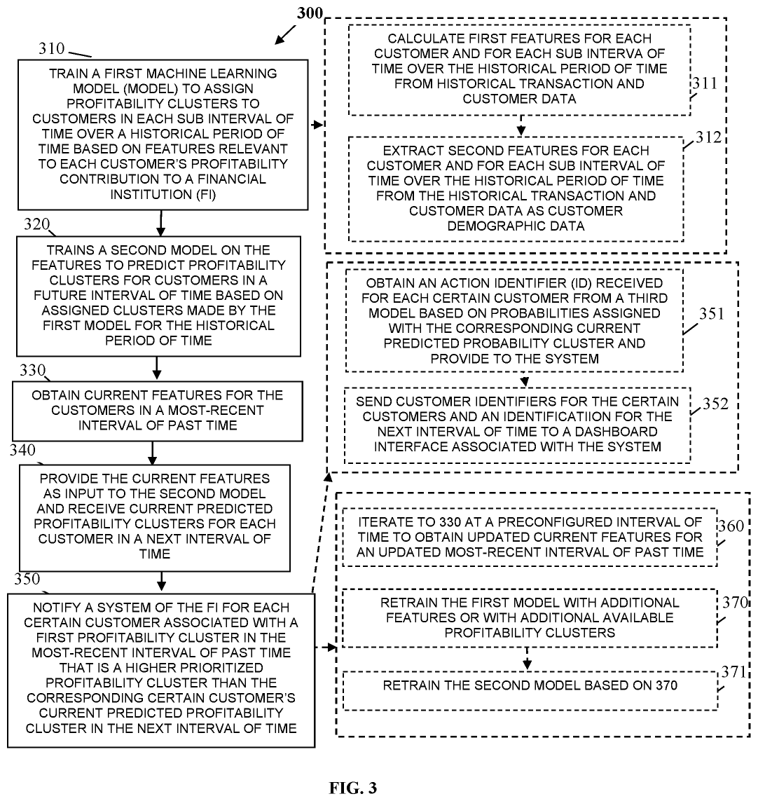

FIG. 3 is a flow diagram of a method 300 for self-supervised churn predictions, according to an example embodiment. The software module(s) that implements the method 300 is referred to as a “self-supervised customer churn prediction manager.” The self-supervised customer churn prediction manager is implemented as executable instructions programmed and residing within memory and/or a non-transitory computer-readable (processor-readable) storage medium and executed by one or more processors of one or more devices. The processor(s) of the device(s) that executes the self-supervised customer churn prediction manager are specifically configured and programmed to process the self-supervised customer churn prediction manager. The self-supervised customer churn prediction manager has access to one or more network connections during its processing. The network connections are wired, wireless, or a combination of wired and wireless.

In an embodiment, the device that executes the self-supervised customer churn prediction manager is cloud 110 or server 110. In an embodiment, the devices that executes the self-supervised customer churn prediction manager is a given FI server 120. In an embodiment, the self-supervised customer churn prediction manager is a portion, all, or any combination of, predictor 113, 114A, 114B, 115, 116, and/or method 200. In an embodiment, the self-supervised customer churn prediction manager presents another, and in other ways, an enhanced processing perspective to that discussed above with method 200 of FIG. 2.

At 310, self-supervised customer churn prediction manager trains a first model 114A to assign profitability clusters to customers in each sub interval of time over a historical period of time based on features relevant to each customer's profitability contribution to a given FI. In an embodiment, at 311, the self-supervised customer churn prediction manager calculates first features for each customer and for each sub interval of time over the historical period of time from historical transaction and customer data 124. In an embodiment, at 312, the self-supervised customer churn prediction manager extracts second features for each customer and for each sub interval of time over the historical period of time from the historical transaction and customer data 124 as customer demographic data.

At 320, the self-supervised customer churn prediction manager trains a second model 114B to predict profitability clusters for customers in a future interval of time based on assigned clusters made by the first model 114A for the historical period of time. That is, the second model 114B learns to provide profitability clusters and predict profitability clusters based on the original assigned clusters produced by the first model 114A.

At 330, the self-supervised customer churn prediction manager obtains current features for the customers in a most-recent interval of past time. For example, the most-recent interval of past time is 6 moths or 3 months back from a current date.

At 340, the self-supervised customer churn prediction manager provides the current features as input to the second model 114B. The self-supervised customer churn prediction manager receives current predicted profitability clusters for each customer in a next interval of time. The second model 114B also provides profitability clusters for each sub interval of time over the most-recent interval of past time along with the current predicted profitability clusters.

At 350, the self-supervised customer churn prediction manager notifies a system 123 of the FI for each certain customer associated with a first profitability cluster in the most-recent interval of past time that is a higher-prioritized profitability cluster that the corresponding certain customer's predicted profitability cluster in the next interval of time. That is, the self-supervised customer churn prediction manager compares a given customer's profitability clusters assigned for the most-recent interval of past time against the predicted profitability cluster to detect a trend or a pattern indicating that the customer is likely to become less profitable for the FI that that customer has been.

In an embodiment, at 351, the self-supervised customer churn prediction manager obtains an action identifier received for each certain customer from a third model 114C based on probabilities assigned with the corresponding predicted probability cluster. The self-supervised customer churn prediction manager provides customer identifiers for the corresponding customers and the corresponding action identifier to the system 123 using API 115. In an embodiment, at 352, the self-supervised customer churn prediction manager sends customer identifiers for the certain customers and an identification for the next interval of time to a dashboard interface associated with the system 123.

In an embodiment, at 360, the self-supervised customer churn prediction manager iterates to 330 at a preconfigured interval of time to obtain updated current features for an updated most-recent interval of past time. In an embodiment, at 370, the self-supervised customer churn prediction manager retrains the first model 114A with additional features and/or with additional profitability clusters that are available for the first model 114A to use when providing profitability clusters for customers. In an embodiment of 370 and at 371, the self-supervised customer churn prediction manager retrains the second model 114B based on the retraining of the first model 114A at 370.

The above description is illustrative, and not restrictive. Other embodiments will be apparent to those of skill in the art upon reviewing the above description. The scope of embodiments should therefore be determined with reference to the appended claims, along with the full scope of equivalents to which such claims are entitled.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner. Furthermore, although the software modules are illustrated as executing on one piece of hardware, the software may be distributed over multiple processors or in any other convenient manner.

The above description is illustrative, and not restrictive. Other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
identifying features relevant to customer profitability for a most-recent interval of past time from a financial institution (FI);
assigning each customer of a plurality of customers to a profitability cluster of a plurality of profitability clusters in each sub interval of time over the most-recent interval of past time based on the features;
predicting, for each customer, a predicted profitability cluster in a future interval of time based on the features; and
flagging certain customers associated with a given profitability cluster that is a higher prioritized profitability cluster in the most-recent interval of time than a corresponding predicted profitability cluster in the future interval of time.

2. The method of claim 1 further comprising:
iterating to the identifying at a preconfigured interval of time and identifying updated features for an updated most-recent interval of past time.

3. The method of claim 1 further comprising, sending a message to a system of the FI, wherein the message includes customer identifiers for the certain customers and identifies the future interval of time.

4. The method of claim 1 further comprising, sending customer identifiers for the certain customers and an identification of the future interval of time to a dashboard interface associated with a system of the FI.

5. The method of claim 1 further comprising, generating a report for the future interval of time, and sending the report to a system of the FI, wherein the report includes customer identifiers for the certain customers and a probability for each customer identifier indicating a likelihood the corresponding customer is going to churn within the future interval of time.

6. The method of claim 1 further comprising:
predicting a mitigation action for each certain customer, wherein each mitigation action associated with avoiding the corresponding predicted profitability cluster in the future interval of time; and
sending each customer identifier, corresponding mitigation action, and an identification of the future interval of time to a system of the FI.

7. The method of claim 1, wherein identifying further includes calculating first features for each customer and each sub interval of time within the most-recent past interval of time from transaction and customer data of the FI, wherein the first features include, per sub interval of time, average time between transactions, total number of the transactions, and sum of customer checking spend, savings, retirement, certificate accounts, and outstanding loan balances.

8. The method of claim 7, wherein identifying further includes extracting second features as demographic data for each customer and each sub interval of time within the most-recent past interval of time from the transaction and customer data.

9. The method of claim 8, wherein assigning further includes providing the first features and the second features to a self-supervised machine learning model (model) and receiving assigned profitability clusters for each customer within each sub interval of time as output from the model.

10. The method of claim 9, wherein predicting further includes receiving the corresponding predicted profitability cluster for each customer for the future interval of time as output from the model.

11. A method, comprising:
training a first machine learning model (model) to assign profitability clusters to customers in each sub interval of time over a historical period of time based on features relevant to each customer's profitability contribution to a financial institution (FI);
training a second model on the features to predict profitability clusters for customers in a future interval of time based on assigned clusters made by the first model for the historical period of time;
obtaining current features for the customers in a most-recent interval of past time;
providing the current features as input to the second model and receiving current predicted profitability clusters for each customer in a next interval of time; and
notifying a system of the FI for each certain customer associated with a first profitability cluster in the most-recent interval of past time that is a higher prioritized profitability cluster than a corresponding certain customer's current predicted profitability cluster in the next interval of time.

12. The method of claim 11 further comprising:
iterating to the obtaining at a preconfigured interval of time to obtain updated current features for an updated most-recent interval of past time.

13. The method of claim 11 further comprising:
retraining the first model with additional features or with additional available profitability clusters.

14. The method of claim 13 further comprising:
retraining the second model based on retaining of the first model.

15. The method of claim 11, wherein training the first model further includes calculating first features for each customer and for each sub interval of time over the historical period of time from historical transaction and customer data of the FI.

16. The method of claim 15, wherein calculating further includes extracting second features for each customer and for each sub interval of time over the historical period of time from historical transaction and customer data as customer demographic data.

17. The method of claim 11, wherein notifying further includes obtaining an action identifier received for each certain customer from a third model based on probabilities associated with the corresponding current predicted profitability cluster and providing the corresponding action identifier for each certain customer to the system to process.

18. The method of claim 11, wherein notifying further includes sending customer identifiers for the certain customers and an identification for the next interval of time to a dashboard interface associated with the system.

19. A system, comprising:
at least one server comprising at least one processor and a non-transitory computer-readable storage medium;
the non-transitory computer-readable storage medium comprising executable instructions; and
the executable instructions when executed by at least one processor cause the at least one processor to perform operations, comprising:
clustering customers to profitability clusters over a most-recent interval of past time based on features relevant to customer profitability contribution to a financial institution (FI);
predicting profitability clusters for the customers in a next interval of time; and
notifying a system of the FI of certain customers assigned to a first profitability cluster in the most-recent interval of past time that is of a higher prioritized profitability cluster than a second profitability cluster assigned in the next interval of time, wherein the certain customers are identified as likely to churn within the next interval of time.

20. The system of claim 19, the executable instructions when executed by at least one processor further cause the at least one processor to perform additional operations, comprising:
notifying the system of the FI of additional customers assisted to a third profitability cluster in the most-recent interval of past time that is of a lower prioritized profitability cluster than a fourth profitability cluster assigned in the next interval of time, wherein the additional customers are identified as potential valuable customers to the FI within the next interval of time.
